(19) United States
(12) Patent Application Publication
(10) Pub. No.: US 2026/0243721 A1
(43) Pub. Date: Aug. 20, 2026

(54) MEMS-Type Semiconductor Gas Sensor

(71) Applicant: NEW COSMOS ELECTRIC CO., LTD., Osaka-shi (JP)

(72) Inventors: Takafumi Taniguchi, Osaka-shi (JP); Hirokazu Mitsuhashi, Osaka-shi (JP); Taishi Orita, Osaka-shi (JP); Yasuhisa Kitagawa, Osaka-shi (JP); Rui Kakunaka, Osaka-shi (JP)

(21) Appl. No.: 19/471,982

(22) PCT Filed: May 10, 2024
(86) PCT No.: PCT/JP2024/017458

§ 371 Date: Oct. 2, 2025

(30) Foreign Application Priority Data
Jun. 27, 2023 (JP) 2023-105061

(51) Int. Cl. G01N 27/12

(52) U.S. Cl. CPC G01N 27/128

(57) ABSTRACT

A MEMS-type semiconductor gas sensor of the present disclosure includes a MEMS-type semiconductor gas detection element configured to detect a target gas contained in a gas to be measured, a housing that houses the MEMS-type semiconductor gas detection element and has an opening through which the gas to be measured can flow, and a filter member disposed between the opening and the gas detection element. The filter member includes a first filter member configured to remove siloxanes and a second filter member configured to remove sulfur-based gases. The first filter member has a greater removal capability for siloxanes than the second filter member The second filter member has a greater removal capability for sulfur-based gases than the first filter member. The filter member does not include a precious metal.

### CROSS-REFERENCE TO RELATED APPLICATIONS

This application is the United States national phase of International Patent Application No. PCT/JP2024/017458 filed May 10, 2024, and claims priority to Japanese Patent Application No. 2023-105061 filed Jun. 27, 2023, the disclosures of which are hereby incorporated by reference in their entireties.

### BACKGROUND

### Technical Field

The present disclosure relates to a MEMS-type semiconductor gas sensor.

### Technical Considerations

A semiconductor gas detection element that is produced using MEMS (Micro Electro Mechanical System) technique as disclosed in JP 2014-041164 A, for example, has been used conventionally as a gas detection element that detects a target gas contained in a gas to be measured such as the atmosphere. As the size of the MEMS-type semiconductor gas detection element is reduced through the MEMS technique, a low power consumption can be achieved by driving it intermittently. However, because the duration at high temperature becomes shorter under intermittent driving in the MEMS-type semiconductor gas detection element, there is a high possibility of sensitivity fluctuation due to poisoning if the gas to be measured contains siloxanes (such as octamethylcyclotetrasiloxane), sulfur-based gases (such as hydrogen sulfide), or the like. Therefore, the MEMS-type semiconductor gas detection element requires more advanced anti-poisoning measures compared with other types of gas detection elements.

In order to suppress poisoning of a gas detection element caused by siloxanes or sulfur-based gases, JP 2020-076690 A proposes using, for example, a filter including activated carbon and a precious metal catalyst. As described in JP 2020-076690 A, the precious metal catalyst adsorbs siloxanes and sulfur-based gases, while oxidizing ethanol to produce acetic acid if ethanol is present in the gas to be measured. Acetic acid, like siloxanes and sulfur-based gases, poisons the gas detection element and causes its sensitivity to fluctuate. Accordingly, J P 2020-076690 A proposes neutralizing the acetic acid produced by the precious metal catalyst with calcium carbonate or the like, in order to suppress poisoning of the gas detection element caused by acetic acid.

### SUMMARY

As described above, in a gas detection element such as a MEMS-type semiconductor gas detection element that is driven intermittently and has a short duration at high temperature, more advanced anti-poisoning measures are required compared with other types of gas detection elements. In a configuration such as that of JP 2020-076690 A, in which acetic acid is generated by a precious metal catalyst, a problem arises in that acetic acid cannot be sufficiently neutralized if it is generated in excess of an allowable amount. Therefore, in a MEMS-type semiconductor gas detection element, it is difficult to sufficiently suppress sensitivity fluctuation caused by poisoning by means of the filter described in JP 2020-076690 A.

The present disclosure is made in view of the above-described problem, and aims to provide a MEMS-type semiconductor gas sensor capable of suppressing sensitivity fluctuation of a MEMS-type semiconductor gas detection element, even when siloxanes, sulfur-based gases, and ethanol are present in a gas to be measured.

The MEMS-type semiconductor gas sensor of the present disclosure comprises: a MEMS-type semiconductor gas detection element configured to detect a target gas contained in a gas to be measured; a housing that houses the MEMS-type semiconductor gas detection element and has an opening through which the gas to be measured can flow; and a filter member disposed between the opening and the MEMS-type semiconductor gas detection element inside the housing, wherein the filter member comprises a first filter member configured to remove siloxanes and a second filter member configured to remove sulfur-based gases, wherein the first filter member has a greater removal capability for siloxanes than the second filter member, wherein the second filter member has a greater removal capability for sulfur-based gases than the first filter member, and wherein the filter member does not include a precious metal.

### BRIEF DESCRIPTION OF THE DRAWINGS

FIG. 1 is a schematic cross-sectional view of a MEMS-type semiconductor gas sensor according to an embodiment of the present disclosure.

FIG. 2 is a schematic cross-sectional view of a MEMS-type semiconductor gas detection element included in the MEMS-type semiconductor gas sensor shown in FIG. 1.

### DESCRIPTION

A MEMS-type semiconductor gas sensor (hereinafter, simply referred to as a “gas sensor”) according to an embodiment of the present disclosure will be described below with reference to the accompanying drawings. However, the embodiment shown below is one example, and the gas sensor of the present disclosure is not limited to the following examples.

The gas sensor of this embodiment is used to detect a target gas in a gas to be measured, such as an environmental atmosphere including, for example, the atmosphere, which may contain the target gas. The target gas refers to a gas that can be detected by a MEMS-type semiconductor gas detection element 2 described below and that is subject to detection. The target gas is not particularly limited, and flammable gases such as methane, butane, isobutane, propane, and hydrogen may be exemplified, with isobutane and propane being exemplified in particular. The detection of the target gas includes determination of presence or absence of the target gas in the gas to be measured and determination of the concentration of the target gas in the gas to be measured.

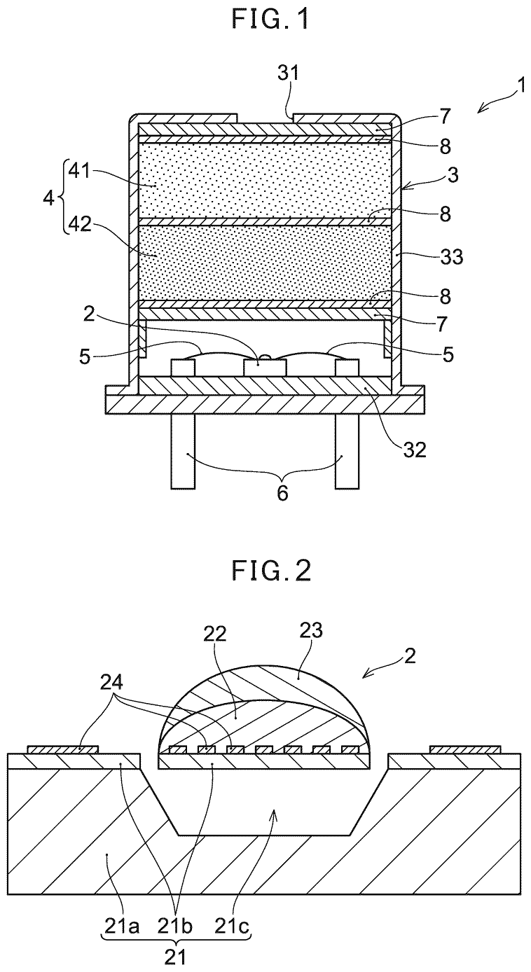

As shown in FIG. 1, the gas sensor 1 comprises a MEMS-type semiconductor gas detection element (hereinafter, simply referred to as a “gas detection element”) 2, a housing 3 that houses the gas detection element 2, and a filter member 4 disposed inside the housing 3. For example, the gas sensor 1 can be incorporated into a gas detector to be used. The gas detector may comprise: a control unit incorporated into a detection circuit (such as a bridge circuit) via a lead wire 5 and an electrode 6, the control unit controlling a voltage applied in the detection circuit and calculating a gas concentration of a target gas based on a sensor output provided from the detection circuit; a display unit that displays the gas concentration of the target gas; a notification unit that provides a notification when the calculated gas concentration exceeds a predetermined threshold value.

The gas detection element 2 is configured to detect the target gas contained in the gas to be measured. The gas detection element 2 is configured as a semiconductor type, and detects the target gas by utilizing a change in electrical resistance (or electrical conductivity) resulting from a chemical reaction with the target gas. Further, as shown in FIG. 2, the gas detection element 2 is formed as a MEMS (Micro Electro Mechanical System) type. The MEMS type refers to a device structure in which at least part of the components is integrated on a substrate such as a silicon substrate through a microfabrication technique. The gas detection element 2 can be reduced in size and can be driven with low power consumption by being formed as a MEMS type, compared with a coil type.

The gas detection element 2 may be configured as any MEMS-type semiconductor gas sensor element, and its configuration is not particularly limited. In this embodiment, the gas detection element 2 is configured to detect isobutane and propane. As shown in FIG. 2, the gas detection element 2 comprises a substrate 21 such as a silicon substrate, a gas-sensitive portion 22 provided on the substrate 21, and a catalyst protection layer 23 covering the gas-sensitive portion 22. The gas detection element 2 further comprises a resistor 24 provided on the substrate 21 so as to be covered with the gas-sensitive portion 22.

The substrate 21 supports the gas-sensitive portion 22, the catalyst protection layer 23, and the resistor 24. As shown in FIG. 2, the substrate 21 comprises a substrate main body 21a, and an insulating support membrane 21b formed on the substrate main body 21a. The insulating support membrane 21b includes a portion formed on the substrate main body 21a on the lower side thereof in contact with the substrate main body 21a, and a portion provided on a cavity 21c of the substrate main body 21a, spaced apart from the substrate main body 21a. The gas-sensitive portion 22, the catalyst protection layer 23, and the resistor 24 are provided on the portion of the insulating support membrane 21b provided on the cavity 21c. The substrate 21 may be formed of a silicon substrate, for example, and the substrate main body 21a and the insulating support membrane 21b may be formed of silicon and a silicon oxide film, or the like, respectively.

The gas-sensitive portion 22 is a portion mainly composed of a metal oxide semiconductor, the electrical resistance of which changes in accordance with a chemical reaction with the target gas. The gas-sensitive portion 22 can be formed, for example, by adding a metal such as antimony, niobium, or the like as a donor to a metal oxide semiconductor such as tin oxide, indium oxide, or the like. The gas-sensitive portion 22 may further include a precious metal catalyst such as platinum, palladium, etc. In this embodiment, the gas-sensitive portion 22 includes tin oxide as a metal oxide semiconductor, antimony as a donor, and platinum as a precious metal catalyst.

The catalyst protection layer 23 is a portion that suppresses a reaction between an interference gas, which hinders detection of the target gas, and the surface of the gas-sensitive portion 22. The catalyst protection layer 23 may have a layer structure designed appropriately in accordance with the interference gas so as to suppress the reaction between the gas-sensitive portion 22 and the interference gas. The catalyst protection layer 23 can be formed, for example, by coating the surface of the gas-sensitive portion 22 with a support on which a precious metal catalyst such as platinum, palladium, or the like is supported, the support being made of a metal oxide such as alumina, silica, or the like. In this embodiment, the catalyst protection layer 23 includes palladium-supported alumina.

The resistor 24 functions as a heating electrode that heats the gas-sensitive portion 22 (and the catalyst protection layer 23) to a suitable temperature for detecting the target gas (e.g., 400-600° C.) when a predetermined voltage is applied. Further, the resistor 24 also functions as a resistance detection electrode that detects a change in electrical resistance value of the gas-sensitive portion 22. The gas detection element 2 detects the target gas based on a change in electrical resistance value of the gas-sensitive portion 22 detected by the resistor 24. The resistor 24 can be formed, for example, by depositing a precious metal such as platinum, platinum-rhodium alloy, or the like on the substrate 21 (insulating support membrane 21b) using a deposition method such as sputtering. It should be noted that, in this embodiment, the resistor 24 is used as both a heating electrode and a resistance detection electrode, but the heating electrode and the resistance detection electrode may also be provided separately.

As shown in FIG. 1, the housing 3 has a space inside for housing the gas detection element 2, and has an opening 31 through which the gas to be measured can flow so as to be introduced into the space. In this embodiment, the opening 31 is provided at a portion of the center on one end side of the housing 3 (the upper side in FIG. 1). However, the size and position of the opening are not particularly limited as long as the opening is configured to allow the gas to be measured to flow. For example, the opening may be provided across the entire one end side of the housing, or may be provided in another portion of the housing. Further, in this embodiment, the housing 3 houses the gas detection element 2 on the other side of the space inside the housing 3 (the lower side in FIG. 1). However, the position of the gas detection element is not particularly limited as long as it can be housed in the space inside the housing, and the gas detection element may be housed in another portion of the space inside the housing.

The configuration of the housing 3 is not particularly limited as long as the housing can house the gas detection element 2 and has the opening 31 allowing the gas to be measured to flow therethrough. In this embodiment, as shown in FIG. 1, the housing 3 comprises a base 32 on which the gas detection element 2 is installed, and a cap 33 fixed to the base 32 so as to surround the gas detection element 2. The base 32 is further provided with the lead wire 5 and the electrode 6 for connecting the gas detection element 2 to the detection circuit (e.g., a bridge circuit). The cap 33 is formed into a substantially tubular shape having the opening 31 on one end side (the upper side of FIG. 1) and another opening on the other end side (the lower side in FIG. 1), the other opening being closed by the base 32. With the other end side of the cap 33 fixed to the base 32 and the opening at the other end side of the cap 33 closed by the base 32, the space for housing the gas detection element 2 is formed inside the cap 33. It should be noted that, in this embodiment, the housing 3 has a single-layer structure comprising a single cap 33, but the housing may have a multi-layer structure comprising a plurality of caps in which one cap is covered with another cap.

As shown in FIG. 1, the filter member 4 comprises a first filter member 41 configured to remove siloxanes and a second filter member 42 configured to remove sulfur-based gases, and is disposed between the opening 31 and the gas detection element 2 inside the housing 3. Since the filter member 4 is disposed between the opening 31 and the gas detection element 2, it removes siloxanes and sulfur-based gases from the gas to be measured that reaches the gas detection element 2 through the opening 31. Here, in the specification, “removing siloxanes/sulfur-based gases” means at least partially removing, and preferably entirely removing, siloxanes/sulfur-based gases from the gas to be measured. In addition, “removing siloxanes/sulfur-based gases” includes, for example, removing siloxanes/sulfur-based gases from the gas to be measured that reaches the gas detection element 2 by adsorbing them to the filter member 4, or removing siloxanes/sulfur-based gases from the gas to be measured that reaches the gas detection element 2 by decomposing them with the filter member 4. In the gas sensor 1, even when the gas to be measured contains siloxanes and sulfur-based gases, by removing them with the filter member 4, poisoning of the gas detection element 2 caused thereby is suppressed, thereby suppressing sensitivity fluctuation of the gas detection element 2.

The first filter member 41 is composed of a material having a greater removal capability for siloxanes than the second filter member 42. The first filter member 41 removes siloxanes from the gas to be measured that reaches the gas detection element 2 through the opening 31. The siloxanes removed by the first filter member 41 refer to gases composed of compounds having a siloxane bond, and examples include hexamethylcyclotrisiloxane (D3), octamethylcyclotetrasiloxane (D4), decamethylcyclopentasiloxane (D5), and dodecamethylcyclohexasiloxane (D6).

The material of the first filter member 41 is not particularly limited as long as the first filter member 41 is composed of a material having at least a greater removal capability for siloxanes than the second filter member 42, but the first filter member 41 preferably includes silica gel. The first filter member 41 can further suppress sensitivity fluctuation of the gas detection element 2 by including silica gel, which further enhances the removal capability for siloxanes. The silica gel is not particularly limited, but an organic sulfonic acid-supported silica gel having a greater removal capability for siloxanes can be appropriately used. It should be noted that silica gel can also be preferably used in that it can absorb and remove moisture that may cause sensitivity fluctuation of the gas detection element 2.

The form of the material of the first filter member 41 is not particularly limited as long as the first filter member 41 is configured to have a removal capability for siloxanes at least greater than that of the second filter member 42, and the first filter member 41 can be formed of a material in the form of granules, powder, fibers, sheets, discs, or the like. For example, the first filter member 41 can be formed by filling granular filter material into the housing 3.

The second filter member 42 is composed of a material having a greater removal capability for sulfur-based gases than the first filter member 41. The second filter member 42 removes sulfur-based gases from the gas to be measured that reaches the gas detection element 2 through the opening 31. The sulfur-based gases removed by the second filter member 42 refer to gases containing sulfur, and examples include hydrogen sulfide and sulfur dioxide.

The material of the second filter member 42 is not particularly limited as long as the second filter member 42 is composed of a material having a removal capability for sulfur-based gases at least greater than that of the first filter member 41, but the second filter member 42 preferably includes at least one selected from zinc aluminosilicate, allophane, and manganese oxide. The second filter member 42 preferably includes zinc aluminosilicate or allophane from the viewpoint of further suppressing generation of an ethanol oxidation product which will be described below. Zinc aluminosilicate is a composite oxide including aluminum oxide (Al₂O₃ or the like), silicon oxide (SiO₂ or the like), and zinc oxide (ZnO or the like), and includes what is called a zinc aluminosilicate-based mineral. Zinc aluminosilicate preferably has a structure in which silica-zinc particles are encapsulated in silica-alumina gel. Further, allophane is a clay mineraloid composed of an amorphous or poorly crystalline hydrated aluminum silicate.

The form of the material of the second filter member 42 is not particularly limited as long as the second filter member 42 is configured to have a removal capability for sulfur-based gases at least greater than that of the first filter member 41, and the second filter member 42 can be formed of a material in the form of granules, powder, fibers, sheets, discs, or the like. For example, the second filter member 42 can be formed by filling a granular filter material into the housing 3.

As shown in FIG. 1, the filter member 4 is disposed between the opening 31 and the gas detection element 2 inside the housing 3, and is arranged so that a part or all of the gas to be measured that flows into the housing 3 through the opening 31 passes through both the first filter member 41 and the second filter member 42 and then reaches the gas detection element 2. In the gas sensor 1, since the gas to be measured passes through both the first filter member 41 and the second filter member 42, siloxanes and sulfur-based gases contained in the gas to be measured are removed. Although it is sufficient for the first filter member 41 and the second filter member 42 to be disposed so that at least the gas to be measured passes both of them, it is preferable, as shown in FIG. 1, that the first filter member 41 and the second filter member 42 are disposed from the opening 31 of the housing 3 toward the gas detection element 2, in the order of the first filter member 41 and the second filter member 42. In other words, it is preferable that the first filter member 41 and the second filter member 42 are disposed so that the gas to be measured flowing into the housing 3 from the opening 31 and reaching the gas detection element 2 first passes through the first filter member 41 and then passes through the second filter member 42. In the gas sensor 1, since the first filter member 41 and then the second filter member 42 are disposed in this order from the upstream side toward the downstream side of the gas to be measured, the filter member 4 can further suppress poisoning caused by siloxanes and sulfur-based gases and also further suppress the influence of ethanol described below, thereby further suppressing sensitivity fluctuation of the gas detection element 2. However, the first filter member 41 and the second filter member 42 may alternatively be disposed in the order of the second filter member 42 and then the first filter member 41 from the opening 31 toward the gas detection element 2, or may be disposed alternately.

In this embodiment, as shown in FIG. 1, the first filter member 41 is disposed adjacent to the opening 31 of the housing 3 via an air-permeable material (e.g., a wire mesh 7 and a non-woven fabric 8) arranged in contact with one end side of the housing 3. The second filter member 42 is disposed adjacent to the first filter member 41 via an air-permeable material (e.g., the non-woven fabric 8) arranged at an intermediate position between one side and the other side of the housing 3. The first filter member 41 and the second filter member 42 are fixed by the air-permeable material (e.g., the non-woven fabric 8 and the wire mesh 7) arranged on the other side of the housing 3 so as to be prevented from moving toward the gas detection element 2 side. It should be noted that the first filter member 41 and the second filter member 42 are not limited to the example shown in the figure, but may be disposed inside the housing forming a two-layer structure in which the first filter member 41 is disposed inside one cap, the second filter member 42 is disposed inside another cap, and the cap in which the second filter member 42 is disposed is inserted into the cap in which the first filter member 41 is disposed.

Here, the filter member 4 does not include a precious metal such as gold, platinum, or palladium. The precious metal oxidizes ethanol to produce ethanol oxidation products (acetaldehyde, acetic acid). The ethanol oxidation products, like siloxanes and sulfur-based gases, poison the gas detection element 2, causing sensitivity fluctuation of the gas detection element 2. In the gas sensor 1, even when the gas to be measured contains ethanol, since the filter member 4 does not include a precious metal, generation of the ethanol oxidation products is suppressed, so that poisoning of the gas detection element 2 caused by the ethanol oxidation products is suppressed, and sensitivity fluctuation of the gas detection element 2 is suppressed.

Although the embodiment of the present disclosure is described above, the present disclosure is not limited to the above-described embodiment. It should be noted that the above-described embodiment mainly describes an example, and the disclosed subject matter may have the following configurations.
(1) A MEMS-type semiconductor gas sensor comprising: a MEMS-type semiconductor gas detection element configured to detect a target gas contained in a gas to be measured, a housing that houses the MEMS-type semiconductor gas detection element and has an opening through which the gas to be measured can flow, and a filter member disposed between the opening and the MEMS-type semiconductor gas detection element inside the housing, wherein the filter member comprises a first filter member configured to remove siloxanes and a second filter member configured to remove sulfur-based gases, wherein the first filter member has a greater removal capability for siloxanes than the second filter member, wherein the second filter member has a greater removal capability for sulfur-based gases than the first filter member, and wherein the filter member does not include a precious metal.

According to the above-described configuration, sensitivity fluctuation of the MEMS-type semiconductor gas detection element can be suppressed, even when siloxanes, sulfur-based gases, and ethanol are present in the gas to be measured.
(2) The MEMS-type semiconductor gas sensor of (1), wherein the first filter member and the second filter member are disposed from the opening toward the MEMS-type semiconductor gas detection element, in the order of the first filter member and the second filter member.

According to the above-described configuration, sensitivity fluctuation of the MEMS-type semiconductor gas detection element can be further suppressed, even when siloxanes, sulfur-based gases, and ethanol are present in the gas to be measured.
(3) The MEMS-type semiconductor gas sensor of (1) or (2), wherein the second filter member includes zinc aluminosilicate or allophane.

According to the above-described configuration, sensitivity fluctuation of the MEMS-type semiconductor gas detection element can be further suppressed, even when siloxanes, sulfur-based gases, and ethanol are present in the gas to be measured.
(4) The MEMS-type semiconductor gas sensor of any one of (1) to (3), wherein the first filter member includes silica gel.

According to the above-described configuration, sensitivity fluctuation of the MEMS-type semiconductor gas detection element can be further suppressed, even when siloxanes, sulfur-based gases, and ethanol are present in the gas to be measured.

Excellent effects of the gas sensor of this embodiment will be described below based on Examples. However, the gas sensor of the present disclosure is not limited by the following Examples.

### (Gas Sensor)

A gas sensor schematically shown in FIG. 1 was fabricated. The gas sensor was fabricated by welding a cap in which a filter member was disposed to a base on which a gas detection element was disposed. The cap was formed to have a height of 12 mm, an outer diameter of 8.3 mmφ, an inner diameter of 7.7 mm, and an opening diameter of 2 mmφ.

A gas detection element schematically shown in FIG. 2 was fabricated. In this case, the substrate was formed of a silicon substrate, the insulating support membrane was formed of a silicon oxide film, and the resistor was formed by sputtering platinum on the insulating support membrane. A gas-sensitive portion was formed by applying a paste containing fine powder of a tin oxide semiconductor with antimony added as a donor and fine powder of platinum onto the resistor on the insulating support membrane to cover the resistor, followed by drying, heating, and sintering. A catalyst protection layer was formed by applying a paste containing fine particles of palladium-supported alumina onto the gas-sensitive portion to cover it, followed by drying and heating. Other steps were carried out by suitable methods.

As filter members, an upstream filter member and a downstream filter member containing the filter materials shown in the following Tables 1 to 4 were disposed at the positions of the first filter member and the second filter member, respectively, shown in FIG. 1. Each of the upstream filter member and the downstream filter member was formed by filling the filter materials shown in the following Tables 1 to 4, which were in granular form, into the cap. Among the filter materials shown in Tables 1 to 4, the acid-supported silica gel means an organic sulfonic acid-supported silica gel, and is an example of the material constituting the above-described first filter member. Further, among the filter materials shown in Tables 1 to 4, zinc aluminosilicate, allophane, and manganese oxide are examples of the materials constituting the above-described second filter member.

### (Exposure Test)

A change in sensitivity of the gas detection element was measured by exposing the gas sensor, respectively, to siloxane, a sulfur-based gas, ethanol, and a mixture of siloxane and ethanol. In the siloxane exposure test (Table 1), the gas sensor was exposed to an atmosphere containing 10 ppm octamethylcyclotetrasiloxane (D4) for 90 days. In the sulfur-based gas exposure test (Table 2), the gas sensor was exposed to an atmosphere containing 5 ppm hydrogen sulfide for 24 hours. In the ethanol exposure test (Table 3), the gas sensor was exposed to an atmosphere containing 250 ppm ethanol for 90 days. In the siloxane and ethanol mixture exposure test (Table 4), the gas sensor was exposed to an atmosphere containing 10 ppm octamethylcyclotetrasiloxane (D4) and 250 ppm ethanol for 90 days. During the exposure period, intermittent driving of the gas detection element was carried out, in which energization of the resistor for 0.1 seconds (heating at 500° C.) and non-energization for 29.9 seconds were alternately repeated.

### (Measurement Condition)

The gas sensor was incorporated into a bridge circuit, and a potential difference generated in the bridge circuit in accordance with a change in the electrical resistance of the gas detection element was measured as a sensor output. The driving condition during the measurement of the gas detection element was set to intermittent driving, in which a detection operation of energizing the resistor for 0.1 seconds (heating at 500° C.) and an operation of non-energization for 29.9 seconds were alternately repeated. The measurement of the sensor output was carried out in an atmosphere free of the target gas before and after the exposure test. The change in sensitivity of the gas detection element was evaluated based on an increase amount in the sensor output from before the exposure test to after the exposure test. The sensor output was normalized by setting the sensor output obtained in an atmosphere containing 2000 ppm propane to 100. Incidentally, in a gas detector configured to issue an alarm upon detection of 2000 ppm propane in the atmosphere, the gas detector would issue an alarm even though propane is absent in the atmosphere if the normalized sensor output exceeds 100 as a result of the exposure test.

### (Results of Siloxane Exposure Test)

Table 1 shows a change in sensor output when the gas sensor was exposed to siloxane. Firstly, in Table 1, the increase in sensor output is significantly suppressed in the cases where the filter includes an acid-supported silica gel (Examples 1 to 6, Comparative Examples 2 to 6) compared with the cases where the filter does not include an acid-supported silica gel (Comparative Examples 1 and 7 to 10), regardless of whether they are Examples or Comparative Examples. This indicates that the acid-supported silica gel removes siloxane from the gas to be measured and suppresses poisoning of the gas detection element. Next, in Table 1, with reference to Comparative Examples 2 to 6 and Comparative Examples 7 to 10, the increase in sensor output is suppressed in the cases where the filter includes an acid-supported silica gel, whereas the sensor output is significantly increased in the cases where the filter does not include an acid-supported silica gel but includes any of zinc aluminosilicate, allophane, manganese oxide, or platinum-supported alumina. This indicates that the acid-supported silica gel has a greater removal capability for siloxane compared with zinc aluminosilicate, allophane, manganese oxide, or platinum-supported alumina. Further, in Table 1, with reference to Examples 1 to 3 and Examples 4 to 6, the increase in sensor output is slightly suppressed when the acid-supported silica gel is disposed on the upstream side compared with the downstream side. This indicates that it is preferable that the acid-supported silica gel is disposed on the upstream side in order to remove siloxane from the gas to be measured.

TABLE 1
Results of siloxane exposure test

| | | | Increase amount in sensor |
|---|---|---|---|
| | Filter configuration | | output in the atmosphere |
| | Upstream filter member | Downstream filter member | after exposure |
| Example 1 | Acid-supported silica gel 90 mg | Zinc aluminosilicate 40 mg | 4 |
| Example 2 | Acid-supported silica gel 90 mg | Allophane 40 mg | 3 |
| Example 3 | Acid-supported silica gel 90 mg | Manganese oxide 40 mg | 5 |
| Example 4 | Zinc aluminosilicate 40 mg | Acid-supported silica gel 90 mg | 11 |
| Example 5 | Allophane 40 mg | Acid-supported silica gel 90 mg | 9 |
| Example 6 | Manganese oxide 40 mg | Acid-supported silica gel 90 mg | 12 |
| Comparative Example 1 | None | None | More than 100 |
| Comparative Example 2 | Acid-supported silica gel 90 mg | Platinum-supported alumina 40 mg | 3 |
| Comparative Example 3 | Acid-supported silica gel 90 mg | Alumina 40 mg | 4 |
| Comparative Example 4 | Acid-supported silica gel 90 mg | Silica alumina 40 mg | 3 |
| Comparative Example 5 | Acid-supported silica gel 90 mg | None | 5 |
| Comparative Example 6 | Acid-supported silica gel 130 mg | None | 2 |
| Comparative Example 7 | Platinum-supported alumina 40 mg | None | More than 100 |
| Comparative Example 8 | Zinc aluminosilicate 40 mg | None | More than 100 |
| Comparative Example 9 | Allophane 40 mg | None | More than 100 |
| Comparative Example 10 | Manganese oxide 40 mg | None | More than 100 |

### (Results of Hydrogen Sulfide Exposure Test)

Table 2 shows a change in sensor output when the gas sensor was exposed to hydrogen sulfide. Firstly, in Table 2, the increase in sensor output is significantly suppressed in the cases where the filter includes any of zinc aluminosilicate, allophane, manganese oxide, or platinum-supported alumina (Examples 1 to 6, Comparative Examples 2 and 7 to 10) compared with the cases where the filter does not include any of zinc aluminosilicate, allophane, manganese oxide, or platinum-supported alumina (Comparative Examples 1 and 3 to 6), regardless of whether they are Examples or Comparative Examples. This indicates that zinc aluminosilicate, allophane, manganese oxide, or platinum-supported alumina removes hydrogen sulfide from the gas to be measured and suppresses poisoning of the gas detection element. Next, in Table 2, with reference to Comparative Examples 3 to 6 and Comparative Examples 7 to 10, the increase in sensor output is suppressed in the cases where the filter includes any of zinc aluminosilicate, allophane, manganese oxide, or platinum-supported alumina, whereas the sensor output is significantly increased in the cases where the filter does not include any of zinc aluminosilicate, allophane, manganese oxide, or platinum-supported alumina but includes an acid-supported silica gel. This indicates that zinc aluminosilicate, allophane, manganese oxide, or platinum-supported alumina has a greater removal capability for hydrogen sulfide compared with the acid-supported silica gel. Further, in Table 2, with reference to Examples 1 to 3 and Examples 4 to 6, the increase in sensor output is slightly suppressed when any of zinc aluminosilicate, allophane, or manganese oxide is disposed on the downstream side compared with the upstream side. This indicates that it is preferable that any of zinc aluminosilicate, allophane, or manganese oxide is disposed on the downstream side in order to remove hydrogen sulfide from the gas to be measured.

TABLE 2
Results of hydrogen sulfide exposure test

| | | | Increase amount in sensor |
|---|---|---|---|
| | Filter configuration | | output in the atmosphere |
| | Upstream filter member | Downstream filter member | after exposure |
| Example 1 | Acid-supported silica gel 90 mg | Zinc aluminosilicate 40 mg | 1 |
| Example 2 | Acid-supported silica gel 90 mg | Allophane 40 mg | 4 |
| Example 3 | Acid-supported silica gel 90 mg | Manganese oxide 40 mg | 2 |
| Example 4 | Zinc aluminosilicate 40 mg | Acid-supported silica gel 90 mg | 2 |
| Example 5 | Allophane 40 mg | Acid-supported silica gel 90 mg | 5 |
| Example 6 | Manganese oxide 40 mg | Acid-supported silica gel 90 mg | 3 |
| Comparative Example 1 | None | None | 74 |
| Comparative Example 2 | Acid-supported silica gel 90 mg | Platinum-supported alumina 40 mg | 2 |
| Comparative Example 3 | Acid-supported silica gel 90 mg | Alumina 40 mg | 63 |
| Comparative Example 4 | Acid-supported silica gel 90 mg | Silica alumina 40 mg | 68 |
| Comparative Example 5 | Acid-supported silica gel 90 mg | None | 71 |
| Comparative Example 6 | Acid-supported silica gel 130 mg | None | 69 |
| Comparative Example 7 | Platinum-supported alumina 40 mg | None | 3 |
| Comparative Example 8 | Zinc aluminosilicate 40 mg | None | 3 |
| Comparative Example 9 | Allophane 40 mg | None | 6 |
| Comparative Example 10 | Manganese oxide 40 mg | None | 4 |

### (Results of Ethanol Exposure Test)

Table 3 shows a change in sensor output when the gas sensor was exposed to ethanol. Firstly, in Table 3, the sensor output is significantly increased in the cases where the filter includes platinum-supported alumina (Comparative Examples 2 and 7) compared with the cases where the filter does not include platinum-supported alumina (Examples 1 to 6, Comparative Examples 1, 3 to 6, 8, and 9), regardless of whether they are Examples or Comparative Examples. Particularly, the sensor output is significantly increased in the cases where the filter includes platinum-supported alumina (Comparative Examples 2 and 7) compared with the cases where the filter includes alumina or silica alumina instead of platinum-supported alumina (Comparative Examples 3 and 4). This indicates that platinum-supported alumina facilitates poisoning of the gas detection element caused by ethanol since it includes platinum. It is considered that this is because platinum oxidizes ethanol to generate ethanol oxidation products, and the generated ethanol oxidation products facilitate the poisoning of the gas detection element. On the other hand, in any of the Examples, the increase in sensor output is suppressed, and the poisoning of the gas detection element is suppressed, since the filter does not include platinum Further, in Table 3, with reference to Examples 1 to 3 and Examples 4 to 6, the increase in sensor output is slightly suppressed in the cases where an acid-supported silica gel is disposed on the upstream side and any of zinc aluminosilicate, allophane or manganese oxide is disposed on the downstream side, compared with the cases with the reverse arrangement. This indicates that it is preferable to dispose an acid-supported silica gel on the upstream side and to dispose any of zinc aluminosilicate, allophane, or manganese oxide on the downstream side, in order to suppress the influence caused by ethanol. Further, in the Examples, in the cases where the filter includes manganese oxide (Examples 3 and 6), the sensor output is slightly increased compared with the cases where the filter includes zinc aluminosilicate or allophane (Examples 1, 2, 4, and 5) instead of manganese oxide. This indicates that it is further preferable that the filter includes zinc aluminosilicate or allophane instead of manganese oxide, in order to further suppress the influence caused by ethanol. It is considered that this is because manganese oxide has a capability to oxidize ethanol, though to a small extent, and generates a small amount of ethanol oxidation products.

TABLE 3
Results of ethanol exposure test

| | | | Increase amount in sensor |
|---|---|---|---|
| | Filter configuration | | output in the atmosphere |
| | Upstream filter member | Downstream filter member | after exposure |
| Example 1 | Acid-supported silica gel 90 mg | Zinc aluminosilicate 40 mg | 10 |
| Example 2 | Acid-supported silica gel 90 mg | Allophane 40 mg | 9 |
| Example 3 | Acid-supported silica gel 90 mg | Manganese oxide 40 mg | 27 |
| Example 4 | Zinc aluminosilicate 40 mg | Acid-supported silica gel 90 mg | 15 |
| Example 5 | Allophane 40 mg | Acid-supported silica gel 90 mg | 12 |
| Example 6 | Manganese oxide 40 mg | Acid-supported silica gel 90 mg | 34 |
| Comparative Example 1 | None | None | 14 |
| Comparative Example 2 | Acid-supported silica gel 90 mg | Platinum-supported alumina 40 mg | More than 100 |
| Comparative Example 3 | Acid-supported silica gel 90 mg | Alumina 40 mg | 12 |
| Comparative Example 4 | Acid-supported silica gel 90 mg | Silica alumina 40 mg | 13 |
| Comparative Example 5 | Acid-supported silica gel 90 mg | None | 16 |
| Comparative Example 6 | Acid-supported silica gel 130 mg | None | 13 |
| Comparative Example 7 | Platinum-supported alumina 40 mg | None | More than 100 |
| Comparative Example 8 | Zinc aluminosilicate 40 mg | None | 15 |
| Comparative Example 9 | Allophane 40 mg | None | 14 |
| Comparative Example 10 | Manganese oxide 40 mg | None | 35 |

### (Results of Siloxane and Ethanol Mixture Exposure Test)

Table 4 shows a change in sensor output when the gas sensor was exposed to the mixture of siloxane and ethanol. Firstly, in Table 4, the increase in sensor output is significantly suppressed in the cases where the filter includes an acid-supported silica gel and does not include platinum-supported alumina (Examples 1 to 6, Comparative Examples 3 to 6) compared with the cases where the filter does not include an acid-supported silica gel or the filter includes platinum-supported alumina (Comparative Examples 1, 2, and 7 to 10), regardless of whether they are Examples or Comparative Examples. This indicates that the acid-supported silica gel removes siloxane from the gas to be measured and suppresses poisoning of the gas detection element, and at the same time, that the poisoning of the gas detection element is suppressed since the filter does not include platinum. For example, it is considered that siloxane is not removed from the gas to be measured in Comparative Examples 1 and 7 to 10 since the filter does not include an acid-supported silica gel, and that the poisoning of the gas detection element is facilitated in Comparative Examples 2 and 7 since the filter includes platinum-supported alumina, thereby generating ethanol oxidation products. On the other hand, in any of the Examples, it is considered that siloxane is removed since the filter includes an acid-supported silica gel and generation of ethanol oxidation products is suppressed since the filter does not include platinum, thereby suppressing the poisoning of the gas detection element. Next, in Table 4, with reference to Examples 1 to 3 and Examples 4 to 6, the increase in sensor output is slightly suppressed in the cases where an acid-supported silica gel is disposed on the upstream side and any of zinc aluminosilicate, allophane, or manganese oxide is disposed on the downstream side, compared with the cases with the reverse arrangement. This indicates that it is preferable to dispose an acid-supported silica gel on the upstream side and to dispose any of zinc aluminosilicate, allophane, or manganese oxide on the downstream side, in order to suppress the increase in sensor output in the presence of siloxane and ethanol.

TABLE 4
Results of siloxane and ethanol mixture exposure test

| | | | Increase amount in sensor |
|---|---|---|---|
| | Filter configuration | | output in the atmosphere |
| | Upstream filter member | Downstream filter member | after exposure |
| Example 1 | Acid-supported silica gel 90 mg | Zinc aluminosilicate 40 mg | 11 |
| Example 2 | Acid-supported silica gel 90 mg | Allophane 40 mg | 10 |
| Example 3 | Acid-supported silica gel 90 mg | Manganese oxide 40 mg | 31 |
| Example 4 | Zinc aluminosilicate 40 mg | Acid-supported silica gel 90 mg | 21 |
| Example 5 | Allophane 40 mg | Acid-supported silica gel 90 mg | 19 |
| Example 6 | Manganese oxide 40 mg | Acid-supported silica gel 90 mg | 42 |
| Comparative Example 1 | None | None | More than 100 |
| Comparative Example 2 | Acid-supported silica gel 90 mg | Platinum-supported alumina 40 mg | More than 100 |
| Comparative Example 3 | Acid-supported silica gel 90 mg | Alumina 40 mg | 15 |
| Comparative Example 4 | Acid-supported silica gel 90 mg | Silica alumina 40 mg | 14 |
| Comparative Example 5 | Acid-supported silica gel 90 mg | None | 18 |
| Comparative Example 6 | Acid-supported silica gel 130 mg | None | 14 |
| Comparative Example 7 | Platinum-supported alumina 40 mg | None | More than 100 |
| Comparative Example 8 | Zinc aluminosilicate 40 mg | None | More than 100 |
| Comparative Example 9 | Allophane 40 mg | None | More than 100 |
| Comparative Example 10 | Manganese oxide 40 mg | None | More than 100 |

### REFERENCE SIGNS LIST

1 MEMS-type semiconductor gas sensor (gas sensor)
2 MEMS-type semiconductor gas detection element (gas detection element)
21 Substrate
21a Substrate main body
21b Insulating support membrane
21c Cavity
22 Gas-sensitive portion
23 Catalyst protection layer
24 Resistor
3 Housing
31 Opening
32 Base
33 Cap
4 Filter member
41 First filter member
42 Second filter member
5 Lead wire
6 Electrode
7 Wire mesh
8 Non-woven fabric

1. A MEMS-type semiconductor gas sensor comprising:
a MEMS-type semiconductor gas detection element configured to detect a target gas contained in a gas to be measured;
a housing that houses the MEMS-type semiconductor gas detection element and has an opening through which the gas to be measured can flow; and
a filter member disposed between the opening and the MEMS-type semiconductor gas detection element inside the housing,
wherein the filter member comprises a first filter member configured to remove siloxanes and a second filter member configured to remove sulfur-based gases,
wherein the first filter member has a greater removal capability for siloxanes than the second filter member,
wherein the second filter member has a greater removal capability for sulfur-based gases than the first filter member,
wherein the filter member does not include a precious metal, and
wherein the second filter member includes zinc aluminosilicate or allophane.

2. The MEMS-type semiconductor gas sensor of claim 1, wherein the first filter member and the second filter member are disposed from the opening toward the MEMS-type semiconductor gas detection element, in the order of the first filter member and the second filter member

3. The MEMS-type semiconductor gas sensor of claim 1, wherein the first filter member includes silica gel.
